(19) United States
(12) Patent Application Publication
(10) Pub. No.: US 2012/0324345 A1
(43) Pub. Date: Dec. 20, 2012

(54) Transitioning between an Editing View and a Backstage View of an Electronic Document

(75) Inventors: Jonathan S. Kaufthal, Seattle, WA (US); Christopher D. Edwards, Seattle, WA (US); Mark E. Pearson, Renton, WA (US)

(73) Assignee: Microsoft Corporation, Redmond, WA (US)

(21) Appl. No.: 13/159,972

(22) Filed: Jun. 14, 2011

(51) Int. Cl. G06F 3/048; G06F 17/24

(52) U.S. Cl. 715/255

(57) ABSTRACT

Transitioning between an editing view and a backstage view of an electronic document may be provided. A user interface may be displayed on a computer which includes an editing view of the electronic document. The computer may then receive an input in the editing view for transitioning from the editing view to the backstage view of the electronic document. The backstage view may include meta information associated with data displayed in the editing view. A transition may then be performed from the editing view to the backstage view of the electronic document. The backstage view including the meta information may then be displayed in the user interface.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Backstage

Some computer application programs which are utilized in the creation and editing of electronic documents incorporate a “backstage view” feature for presenting meta information such as file, printing and sharing information associated with an electronic document. For example, a word processing application may include functionality which allows a user who is editing a document on an editing screen to click on a button in a toolbar to switch to a “backstage” screen presenting file meta information (e.g., file size, file creation date, etc.) about the document being edited. One drawback associated with the aforementioned “backstage” view functionality however, is that the “backstage” screen is completely different than the screen a user is currently viewing. Thus, a user typing a paragraph in a word processing document editing screen may suddenly be presented with an entirely different screen showing document meta information. As a result, this sudden transition between views (i.e., the editing view and the “backstage” view) may cause user confusion as to the relationship of the meta information with the electronic document being edited on the previously viewed screen. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for transitioning between an editing view and a backstage view of an electronic document. A user interface may be displayed on a computer which includes an editing view of the electronic document. The computer may then receive an input in the editing view for transitioning from the editing view to the backstage view of the electronic document. The backstage view may include meta information associated with data displayed in the editing view. A transition may then be performed from the editing view to the backstage view of the electronic document. The backstage view including the meta information may then be displayed in the user interface.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a computing environment which may be utilized for transitioning between an editing view and a backstage view of an electronic document, in accordance with an embodiment;

FIG. 2 is a computer screen display of a user interface showing an editing view of an electronic document, in accordance with an embodiment;

FIG. 3 is a computer screen display of a user interface showing a transition between an editing view of an electronic document and a backstage view of the electronic document, in accordance with an embodiment;

FIG. 4 is a computer screen display of a user interface showing a backstage view of an electronic document following a transition from an editing view, in accordance with an embodiment;

FIG. 5 is a computer screen display of a user interface showing a leading edge of an editing view of an electronic document from within a backstage view, in accordance with an embodiment;

FIG. 6 is a computer screen display of a user interface showing an encroachment of the edge of an editing view of an electronic document into a backstage view, in accordance with an embodiment;

FIG. 7 is a computer screen display of a user interface showing a thumbnail of an editing view of an electronic document from within a backstage view, in accordance with an embodiment; and

FIG. 8 is a flow diagram illustrating a routine for transitioning between an editing view and a backstage view of an electronic document, in accordance with an embodiment.

### DETAILED DESCRIPTION

Embodiments are provided for transitioning between an editing view and a backstage view of an electronic document. A user interface may be displayed on a computer which includes an editing view of the electronic document. The computer may then receive an input in the editing view for transitioning from the editing view to the backstage view of the electronic document. The backstage view may include meta information associated with data displayed in the editing view. A transition may then be performed from the editing view to the backstage view of the electronic document. The backstage view including the meta information may then be displayed in the user interface.

### Exemplary Operating Environment

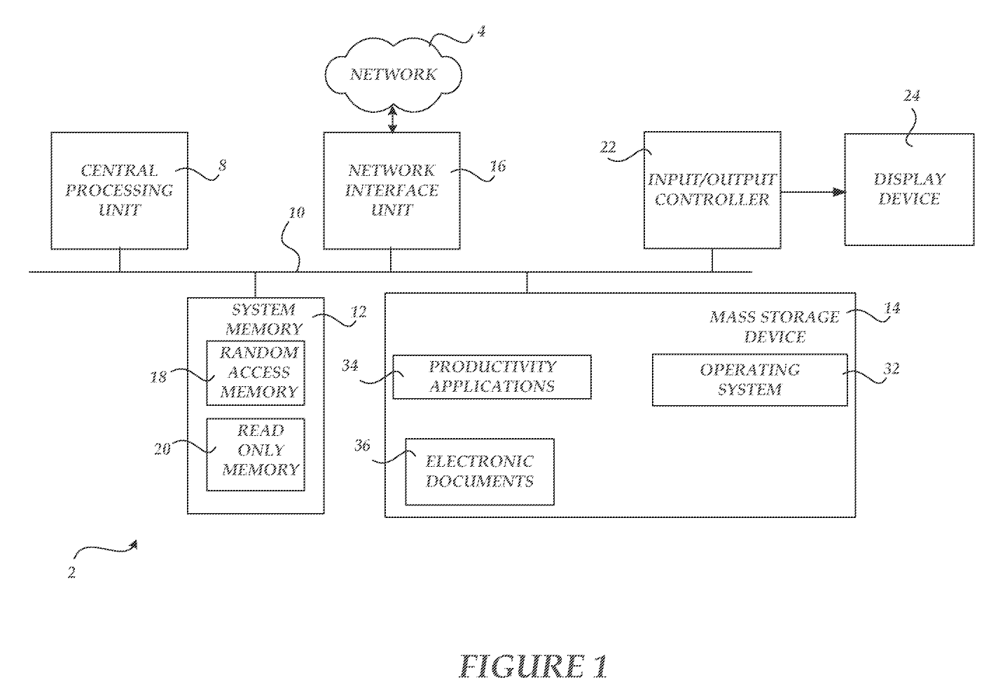

Referring now to FIG. 1, the following discussion is intended to provide a brief, general description of a suitable computing environment in which various illustrative embodiments may be implemented. While various embodiments will be described in the general context of program modules that execute in conjunction with program modules that run on an operating system on a computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

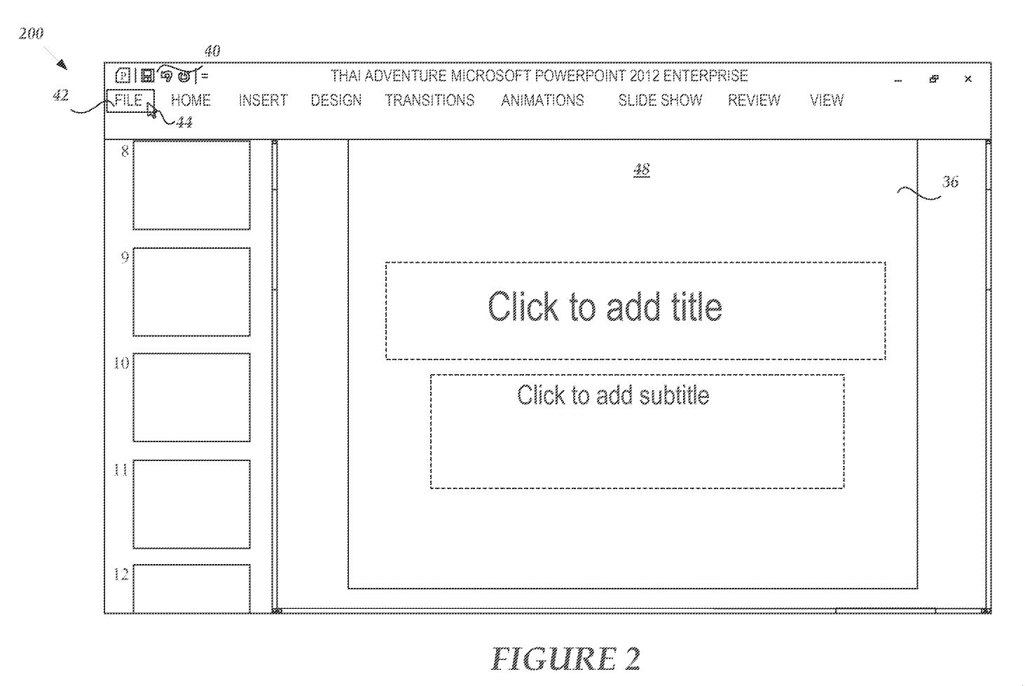

FIG. 1 shows a computer 2 which may include a general purpose desktop, laptop, handheld, tablet, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, productivity applications 34 and electronic documents 36. As will be discussed in greater detail below with respect to FIGS. 2-8, the productivity applications 34 may be configured to generate a user interface for transitioning between an editing view and a backstage view for one or more of the electronic documents 36. As defined herein, an editing view of a document comprises the display of a user interface which may be utilized for the creation and/or editing of electronic documents. A backstage view of a document comprises a user interface for the display of meta information which may be utilized for describing various aspects of an electronic document including, but not limited to, file information, printing information, sharing information, document template information, etc. For example, meta information displayed in a backstage view for a presentation document may include a date the document was created, the date the document was last modified, the total number of slides in the presentation, version information, sharing information and permissions.

In accordance with an embodiment, the productivity applications 34 may comprise the WORD word processing software, POWERPOINT presentation graphics software, EXCEL spreadsheet software, VISIO diagramming software, PROJECT project management software, PUBLISHER publishing software, OUTLOOK personal information management software and the ONENOTE note-taking software from MICROSOFT CORPORATION of Redmond Wash. It should be appreciated that the aforementioned productivity applications 34 may comprise individual application programs or alternatively, may be incorporated into a suite of productivity applications such as the OFFICE application program suite from MICROSOFT CORPORATION. It should be understood, however, that other productivity application programs from other manufacturers may be utilized in accordance with the various embodiments described herein. In accordance with an embodiment, the electronic documents 36 may comprise documents generated by or displayed in a user interface generated by the productivity applications 34. For example, in accordance with various embodiments, the electronic documents 36 may include, without limitation, word processing documents, presentation documents, spreadsheet documents, diagramming documents, project management documents, publishing documents, personal information management documents and note-taking documents.

In accordance with various embodiments, the operating system 32 may be suitable for controlling the operation of a networked computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the computer 2. The term computer-readable media as used herein may include computer storage media. Computer storage media may include volatile and nonvolatile, removable and non-removable media implemented in any method or technology for storage of information, such as computer readable instructions, data structures, program modules, or other data. Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computer 2. Any such computer storage media may be part of the computer 2.

The term computer-readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, the computer 2 may operate in a networked environment using logical connections to remote computers through a network 4 which may comprise, for example, a local network or a wide area network (e.g., the Internet). The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display device 24, a printer, or other type of output device. Additionally, a touch screen can serve as an input and an output mechanism.

FIG. 2 is a computer screen display of a user interface 200 showing an editing view 48 of an electronic document 36, in accordance with an embodiment. The user interface 200, which may be generated by the productivity applications 34, includes a toolbar 40, a File button 42 and a pointer (e.g., a mouse pointer) 44. In accordance with an embodiment, the transition to a backstage view for the electronic document 36 may be initiated by using the pointer 44 to select the File button 42. For example, a user may initiate the transition to the backstage view by clicking on or hovering over the File button 42 in the user interface 200.

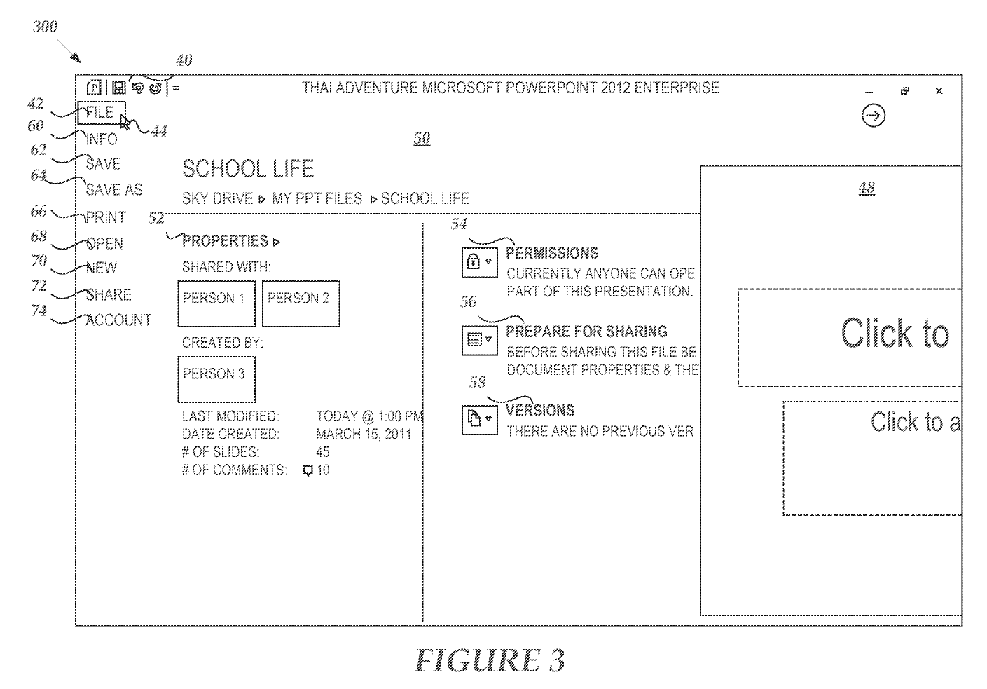

FIG. 3 is a computer screen display of a user interface 300 showing a transition between the editing view 48 of an electronic document 36 and a backstage view 50 of the electronic document 36, in accordance with an embodiment. Like the user interface 200 of FIG. 3, the user interface 300, which may be generated by the productivity applications 34, includes the toolbar 40, the File button 42 and the pointer 44. The user interface 300 also include backstage tabs 60-74 which include an Info tab 60, a Save tab 62, a Save As tab 64, a Print tab 66, an Open tab 68, a New tab 70, a Share tab 72 and an Account tab 74. It should be understood that upon the initiation of the transition from the editing view 48 to the backstage view 50, the productivity applications 34 may be configured cause the backstage tabs 60-74 to “spill out” of the File button 42 so that a user may have immediate access to functionality associated with each tab. The user interface 300 may further include meta information including properties meta information 52, permissions meta information 54, sharing meta information 56 and versions meta information 58. In the user interface 300, the transition to the backstage view 50 may be accomplished by automatically sliding or pushing the editing view 48 off to the side of the computer screen display so that the backstage view 50 may be shown on what will appear to the user as a continuous surface.

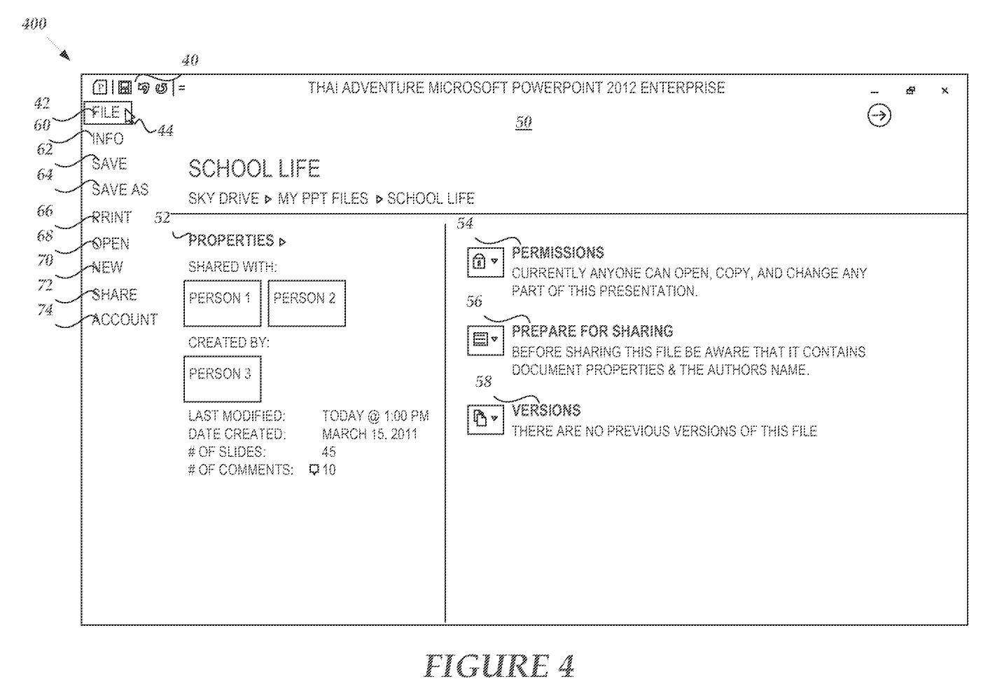

FIG. 4 is a computer screen display of a user interface 400 showing the backstage view 50 of an electronic document 36 following a transition from the editing view 48, in accordance with an embodiment. The user interface 400, which may be generated by the productivity applications 34, includes the toolbar 40, the File button 42 the pointer 44, the backstage tabs 60-74 and the meta information 52-58. It will be appreciated that in this embodiment, the editing view 48 has been pushed completely off of the computer screen display so that only the backstage view 50 is visible to a user.

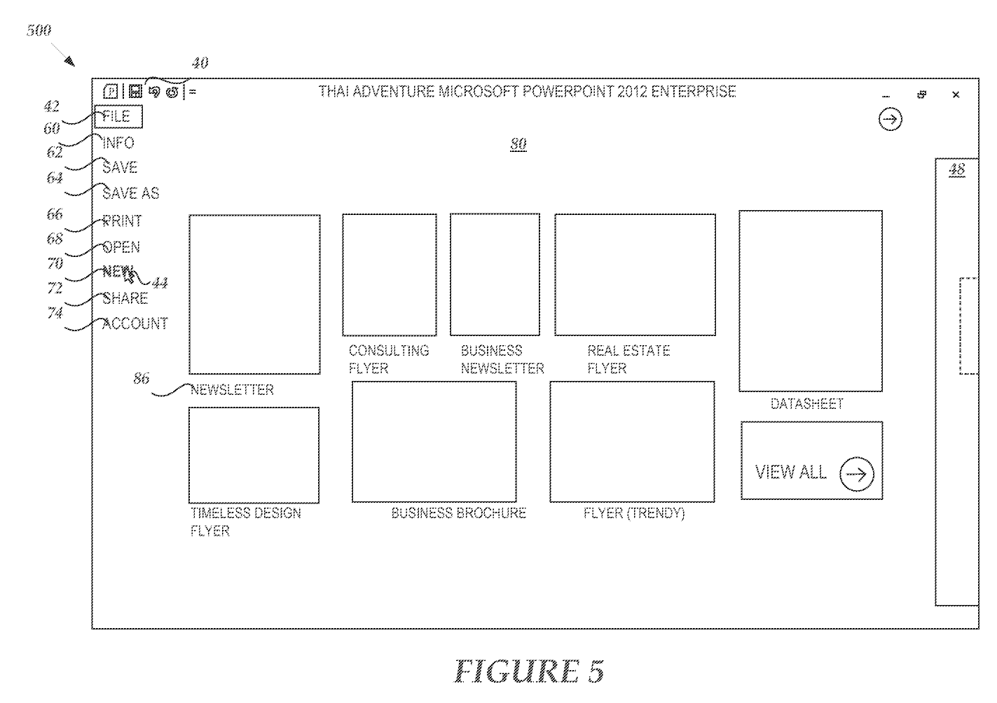

FIG. 5 is a computer screen display of a user interface 500 showing a leading edge of the editing view 48 of an electronic document 36 from within a backstage view 80, in accordance with an embodiment. The user interface 500, which may be generated by the productivity applications 34, includes the toolbar 40, the File button 42 the pointer 44 and the backstage tabs 60-74. It should be appreciated that in this embodiment, the pointer 44 has been used to select the New backstage tab 70 which initiates the display of template meta information for the creation of newsletters, flyers and datasheets such as the newsletter template 86. It should further be appreciated that in this embodiment, a portion of the editing view 48 may be maintained even after the transition to the backstage view 80. In particular, the productivity applications 34 may be configured to display the backstage view 80 such that an edge of the editing view 48 for an electronic document 36 appears to “peek out” on the side of the backstage view 80.

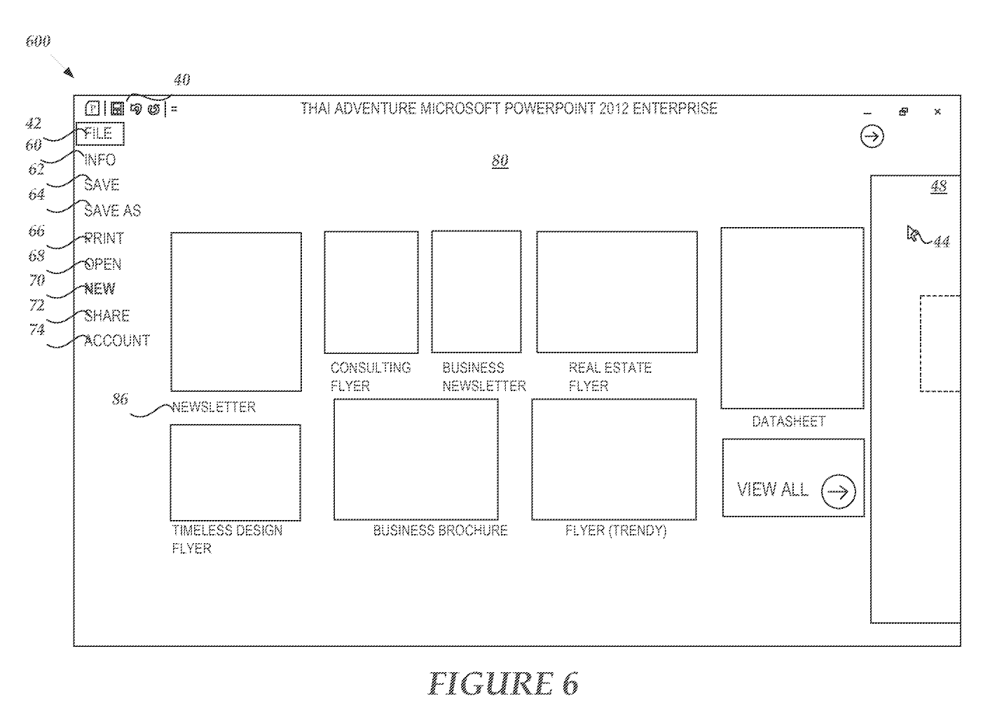

FIG. 6 is a computer screen display of a user interface 600 showing an encroachment of the edge of the editing view 48 of an electronic document 36 into the backstage view 80, in accordance with an embodiment. The user interface 600, which may be generated by the productivity applications 34, includes the toolbar 40, the File button 42 the pointer 44 and the backstage tabs 60-74. It should be appreciated that in this embodiment, the pointer 44 is touching the visible portion of the editing view 48 causing the edge of the electronic document to grow or slide into the backstage view 80 so that a larger portion of the editing view 48 is visible in the user interface 600 than when the pointer 44 was not touching the editing view 48 (e.g., as shown in the user interface 500 of FIG. 5). It should be understood that in this embodiment, the pointer 44 may cause the edge of an electronic document to grow or slide into the backstage view 80 upon coming in contact with the editing view 48 and to shrink or slide out of the backstage view 80 upon being removed from the editing view 48.

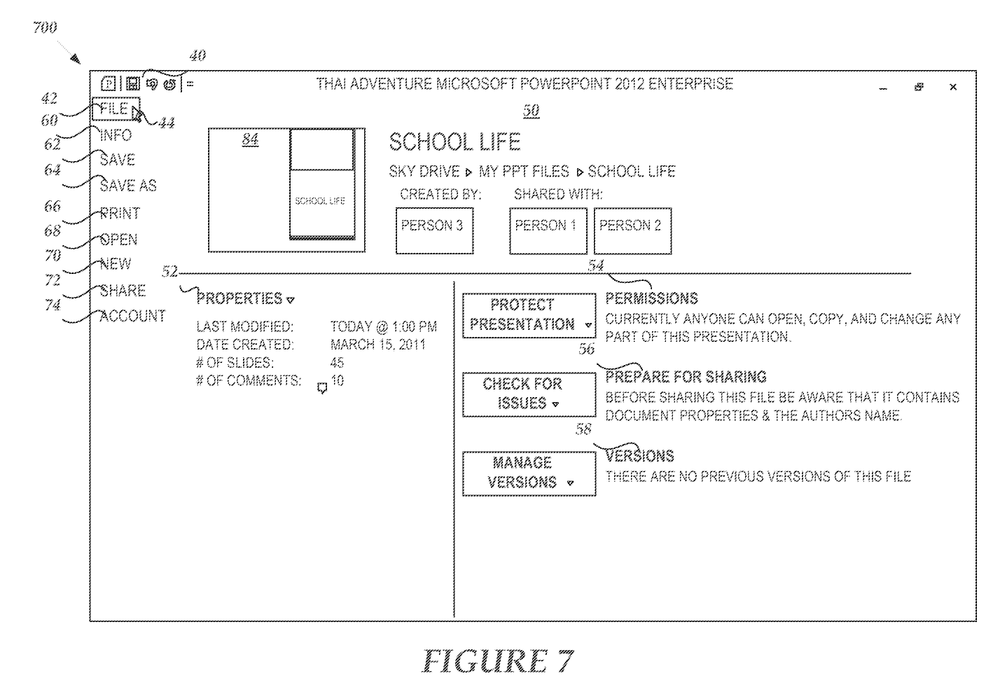

FIG. 7 is a computer screen display of a user interface 700 showing a thumbnail 84 of an editing view of an electronic document 36 from within the backstage view 50, in accordance with an embodiment. The user interface 700, which may be generated by the productivity applications 34, includes the toolbar 40, the File button 42 the pointer 44, the backstage tabs 60-74 and the meta information 52-58. In this embodiment, the thumbnail 84 is shown as a cropped version of an editing view of an electronic document 36. It should be understood that the thumbnail 84 may be created during the transition of the editing view to the backstage view. In particular, during the transition from the editing view to the backstage view 50, the productivity applications 34 may be configured to cause the editing view to shrink or “zoom out” of the user interface 700 to show the backstage view 50 while retaining a thumbnail (i.e., the thumbnail 84) which shows the previous editing view prior to the transition. It should further be understood that in this embodiment, the productivity applications 34 may be configured to crop the editing view represented by the thumbnail 84 so that any user interface elements (e.g., a ribbon, status bar or frame) present in the previous editing view are not shown (i.e., hidden) in the thumbnail 84. Thus, it may be appreciated that the thumbnail 84 may show only the salient visual aspects of an electronic document (e.g., the “School Life” presentation slide).

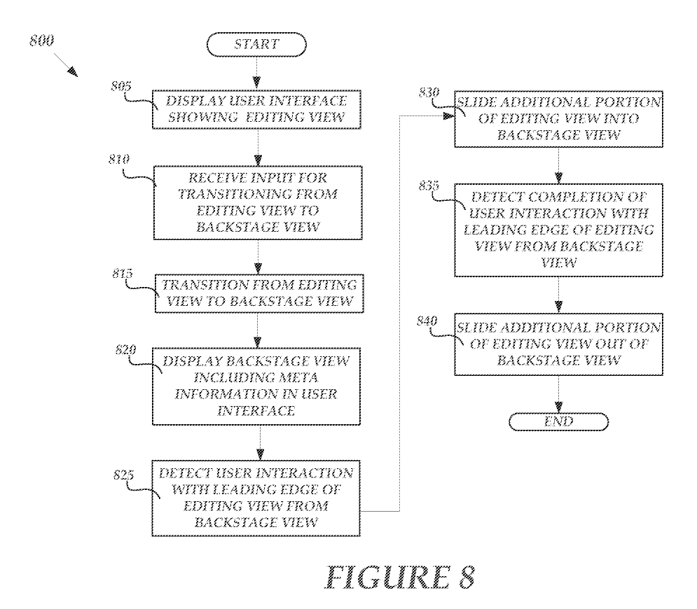

FIG. 8 is a flow diagram illustrating a routine illustrating a routine 800 for transitioning between an editing view and a backstage view of an electronic document 36, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 8 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 800 begins at operation 805, where the productivity applications 34, executing on the computer 2, displays a user interface showing an editing view of an electronic document 36. For example, the productivity applications 34 may generate the user interface 200 discussed above with respect to FIG. 2.

From operation 805, the routine 800 continues to operation 810, where the productivity applications 34 may receive an input for transitioning from an editing view of an electronic document 36 to a backstage view. For example, as discussed above with respect to FIG. 2, a user may use the pointer 44 to click or select the File button 42 in order to initiate the transition to the backstage view.

From operation 810, the routine 800 continues to operation 815, where the productivity applications 34 may transition from an editing view of an electronic document 36 to a backstage view. In accordance with an embodiment and as discussed above with respect to FIG. 3, the transition to the backstage view may be accomplished by automatically sliding or pushing the editing view off to the side of the computer screen display so that the backstage view may be shown on what will appear to the user as a continuous surface. In accordance with another embodiment and as discussed above with respect to FIG. 7, the transition to the backstage view may be accomplished by shrinking or “zooming out” the editing view to show the backstage view.

From operation 815, the routine 800 continues to operation 820, where the productivity applications 34 may display the backstage view including meta information in a user interface. It will be appreciated that illustrative user interfaces showing backstage view meta information are shown in FIGS. 3-7, discussed above. As discussed above with respect to FIG. 7, the displayed backstage view may include a thumbnail of the editing view prior to the transition. The thumbnail of the editing view may have certain previously viewable user interface elements (e.g., ribbon, status bar and frame elements) associated with a full size version of the editing view cropped from the displayed thumbnail image. In accordance with an embodiment and as discussed above with respect to FIG. 4, the editing view may be pushed completely off of a computer screen display such that only the backstage view is displayed to a user in the user interface. In accordance with another embodiment and as discussed above with respect to FIG. 5, the backstage view may be displayed such that a leading edge of the editing view for an electronic document 36 appears to “peek out” on a side of the backstage view.

From operation 820, the routine 800 continues to optional operation 825, where the productivity applications 34 may detect user interaction with a leading edge of an editing view from the currently displayed backstage view. For example, as discussed above with respect to FIG. 6, the productivity applications 34 may be configured to detect when a pointer (e.g., a mouse pointer) is touching a leading edge of the editing view.

From optional operation 825, the routine 800 continues to optional operation 830, where the productivity applications 34 may slide an additional portion of the editing view into the backstage view upon detecting user interaction with the leading edge of the editing view at optional operation 825. For example, as discussed above with respect to FIG. 6, upon detecting that a pointer is touching a leading edge of the editing view, the productivity applications 34 may be configured to cause the editing view to grow or slide into the backstage view so that a larger portion of the editing view is visible in the user interface than when the pointer is not in contact with the editing view.

From optional operation 830, the routine 800 continues to optional operation 835, where the productivity applications 34 may detect the completion of a user interaction with a leading edge of the editing view from within the backstage view. In particular, the productivity applications 34 may be configured to detect when the pointer has been removed from the larger portion of the editing view generated at optional operation 830.

From optional operation 835, the routine 800 continues to optional operation 840, where the productivity applications 34, upon detecting the completion of the user interaction with a leading edge of the editing view at optional operation 835, may be configured to slide the additional portion of the editing view (generated at optional operation 830) back out of the backstage view. In particular, the productivity applications 34 may be configured to revert the editing view to its prior state (e.g., the editing view 48 shown in FIG. 5). From operation 840, the routine 800 then ends.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method for transitioning between an editing view and a backstage view of an electronic document, comprising:
displaying, by a computer, a user interface comprising the editing view of the electronic document;
receiving, by the computer, an input in the editing view for transitioning from the editing view to the backstage view of the electronic document, the backstage view comprising meta information associated with data displayed in the editing view;
transitioning, by the computer, from the editing view to the backstage view of the electronic document; and
displaying, by the computer, the backstage view comprising the meta information in the user interface.

2. The method of claim 1, wherein transitioning, by the computer, from the editing view to the backstage view of the electronic document, comprises sliding the editing view over the user interface to reveal an increasing proportion of the backstage view.

3. The method of claim 1, wherein transitioning, by the computer, from the editing view to the backstage view of the electronic document, comprises reducing the editing view to a thumbnail in the user interface.

4. The method of claim 3, wherein displaying by the computer, the backstage view comprising the meta information in the user interface comprises displaying the thumbnail of the editing view and the meta information in the user interface.

5. The method of claim 3, wherein reducing the editing view to a thumbnail in the user interface comprises cropping user interface elements associated with a full size view of the editing view.

6. The method of claim 1, wherein displaying, by the computer, the backstage view comprising the meta information in the user interface comprises displaying a leading edge of the editing view of the electronic document in the backstage view.

7. The method of claim 6, further comprising:
detecting a user interaction with the leading edge of the editing view of the electronic document in the backstage view;
sliding an additional portion of the editing view of the electronic document into the backstage view for display in the user interface;
detecting a completion of the user interaction with the leading edge of the editing view of the electronic document in the backstage view; and
sliding the additional portion of the editing view of the electronic document out of the backstage view in the user interface.

8. The method of claim 1, wherein displaying, by the computer, the backstage view comprising the meta information in the user interface comprises populating the backstage view in the user interface with a plurality of tabs, each of the plurality of tabs associated with different meta information.

9. A computer system for transitioning between an editing view and a backstage view of an electronic document, comprising:
a memory for storing executable program code; and
a processor, functionally coupled to the memory, the processor being responsive to computer-executable instructions contained in the program code and operative to:
display a user interface comprising the editing view of the electronic document;
receive an input in the editing view for transitioning from the editing view to the backstage view of the electronic document, the backstage view comprising meta information associated with data displayed in the editing view;
transition from the editing view to the backstage view of the electronic document; and
display the backstage view comprising the meta information in the user interface.

10. The computer system of claim 9, wherein the processor, in transitioning from the editing view to the backstage view of the electronic document, is operative to slide the editing view over the user interface to reveal an increasing proportion of the backstage view.

11. The computer system of claim 9, wherein the processor, in transitioning from the editing view to the backstage view of the electronic document, is operative to comprises reducing the editing view to a thumbnail in the user interface.

12. The computer system of claim 11, wherein the processor, in displaying the backstage view comprising the meta information in the user interface, is operative to simultaneously display the thumbnail of the editing view and the meta information in the user interface.

13. The computer system of claim 11, wherein the processor, in reducing the editing view to a thumbnail in the user interface, is operative to crop a plurality of user interface elements associated with a full size view of the editing view, the plurality of user interface comprising a ribbon, a status bar and a frame.

14. The computer system of claim 9, wherein the processor, in displaying the backstage view comprising the meta information in the user interface, is operative to display a leading edge of the editing view of the electronic document in the backstage view.

15. The computer system of claim 14, wherein the processor is further operative to:
detect a user interaction with the leading edge of the editing view of the electronic document in the backstage view;
slide an additional portion of the editing view of the electronic document into the backstage view for display in the user interface;
detect a completion of the user interaction with the leading edge of the editing view of the electronic document in the backstage view; and
slide the additional portion of the editing view of the electronic document out of the backstage view in the user interface.

16. The computer system of claim 9, wherein the processor, in displaying the backstage view comprising the meta information in the user interface, is further operative to populate the backstage view in the user interface with a plurality of tabs, each of the plurality of tabs associated with different meta information.

17. A computer-readable storage medium comprising computer executable instructions which, when executed by a computer, will cause the computer to perform a method for transitioning between an editing view and a backstage view of an electronic document, the method comprising:
displaying a user interface comprising an editing view of an electronic presentation document;
receiving a user input in the editing view for transitioning from the editing view to a backstage view of the electronic presentation document, the backstage view comprising meta information associated with data displayed in the editing view;
transitioning from the editing view to the backstage view of the electronic presentation document by at least one of: sliding the editing view over the user interface to reveal an increasing proportion of the backstage view and reducing the editing view to a thumbnail in the user interface;
populating the backstage view in the user interface with a plurality of tabs, each of the plurality of tabs associated with different meta information; and
displaying the backstage view comprising the meta information in the user interface.

18. The computer-readable storage medium of claim 17, wherein reducing the editing view to a thumbnail in the user interface comprises cropping a plurality of user interface elements associated with a full size view of the editing view, the plurality of user interface elements comprising a ribbon, a status bar and a frame.

19. The computer-readable storage medium of claim 17, wherein displaying the backstage view comprising the meta information in the user interface comprises simultaneously displaying the thumbnail of the editing view and the meta information in the user interface.

20. The computer-readable storage medium of claim 17, wherein displaying the backstage view comprising the meta information in the user interface comprises:
displaying a leading edge of the editing view of the electronic presentation document in the backstage view;
detecting a user interaction with the leading edge of the editing view of the electronic presentation document in the backstage view;
sliding an additional portion of the editing view of the electronic presentation document into the backstage view for display in the user interface;
detecting a completion of the user interaction with the leading edge of the editing view of the electronic presentation document in the backstage view; and
sliding the additional portion of the editing view of the electronic presentation document out of the backstage view in the user interface.
